(19) United States
(12) Patent Application Publication
(10) Pub. No.: US 2012/0314045 A1
(43) Pub. Date: Dec. 13, 2012

(54) WEARABLE SYSTEMS FOR AUDIO, VISUAL AND GAZE MONITORING

(75) Inventors: Aude Billard, St-Sulpice (CH); Basilio Noris, Lausanne (CH); Jean-Baptiste Keller, Lausanne (CH)

(73) Assignee: ECOLE POLYTECHNIQUE FEDERALE DE LAUSANNE (EPFL), Lausanne (CH)

(21) Appl. No.: 13/392,331

(22) PCT Filed: Aug. 26, 2010
(86) PCT No.: PCT/IB10/53835

§ 371 Date: May 16, 2012

Related U.S. Application Data
(60) Provisional application No. 61/236,895, filed on Aug. 26, 2009.

(51) Int. Cl. H04N 7/18

(52) U.S. Cl. 348/78; 348/E07.085

(57) ABSTRACT

A non-obtrusive portable device, wearable from infancy through adulthood, mounted with i) a set of two or more optical device(s) providing visual and audio information as perceived by the user; ii) an actuated mirror or optical device returning visual information on part of the face of the user. The audio-visual signals may be processed on-board or off-board via either hardwired or wireless transmission. Analysis of audio visual signal permit among other things tracking of the user's gaze or facial features and of visual and auditory attention to external stimuli.

### FIELD OF THE INVENTION

This invention generally relates to monitoring visual and auditory attention in adults and infants and more particularly it relates to a wearable system that records audio, visual and gaze information in the environment of a user without direct operator intervention.

### BACKGROUND OF THE INVENTION

Systems and methods for monitoring gaze, in conjunction with visual input from the standpoint of the user find numerous applications, including but not restricted to:
cognitive and developmental psychology, for the study of human visual and auditory attention and their coupling;
computer science and engineering, as a device to support the disabled or to enhance human-machine interaction.
sports applications, as a device recording the action from a first person perspective and monitoring how the athlete responds to the situation.
marketing and consumer research, as a device monitoring what elements, merchandises and advertisement attract the attention of people.
training, as a device evaluating the performance of a trainee or highlighting the know how of an expert.
urbanization, monitoring how people assess and navigate through public and private spaces.
entertainment, to broadcast a closer and intimate point of view of a person of interest.
video logging (vlogs), to keep a record of personal and public events from a first person perspective.

E.g. in cognitive and developmental psychology, such a system may allow researchers to study how children orient their gaze toward a person addressing them when called by their name. In engineering, such wearable system can enhance human-machine interaction by providing the machine, be it a computer or a robot, with precise information on the user's attentional focus during collaborative task solving.

Technology for gaze tracking can be divided into two broad categories: external and wearable. External systems are non invasive and rely on a fixed device, such as a camera or sets of infra-red sensors, attached to a computer screen. For proper detection of the user's eyes, the user must continuously face the device and remain in close vicinity. This restricts importantly the area of movement of the user's head and body. In studies monitoring children' social interaction with others, such systems are inadequate. Indeed, it would be very cumbersome to place someone behind or next to the screen mounted with the eye tracking system and request the child to face the screen while talking to the person. Forcing a child to remain in close vicinity to and facing an apparatus is often very difficult, especially in children with attention disabilities and wearable gaze tracking technologies address the above issues.

Unfortunately, current wearable technologies for gaze tracking rely on systems that partially obtrude the user's field of view. For instance a non-intrusive system with a camera protruding and pointing back to the face (publication WO/1999/005988; Title: AN EYE TRACKER USING AN OFF-AXIS, RING ILLUMINATION SOURCE; Inventors: BORAH, Joshua, D. (US); VALOIS, Charles (US)).

An alternative considers intrusive systems, as a light source highlights the pupil, that takes advantage of the bright corneal reflections to obtain accurate geometrical estimations of the eye direction (publication WO/2004/066097; Title: GAZE TRACKING SYSTEM AND METHOD; Inventors: BORAH, Joshua, D. (US); VALOIS, Charles (US)).

Both of the above approaches make gaze tracking technology unsuitable for studies with very young infants as one cannot foresee the long term effect it could have on eyesight development. Moreover, usual IR light sources are not strong enough to be visible in well-lit situations (e.g. outdoors) and drop in performance when the user wears glasses. For similar reasons, goggles and cameras encumbering the subject's field of vision can not be used either. Further, the fact that the system obtrudes part of the field of view may affect the normal visual behavior of the child, which one seeks to assess, and may also prevent its use with certain children, such as children with autism, who are very reluctant to wear pieces of clothing that reduce their free motion.

Publication WO/2007/043954; Title: EYE TRACKER HAVING AN EXTENDED SPAN OF OPERATING DISTANCES; Inventors: SKOGÖ, Mårten (SE); ELVESJÖ, John (SE); REHNSTRÖM, Bengt (SE) discloses an automatic registration and tracking of the eyes of at least one subject through an optical system, including a lens structure, a mask and an image sensor.

Publication WO/2006/102495; Title: DEVICE AND METHOD FOR TRACKING EYE GAZE DIRECTION; Inventors: COX, David (US); DICARLO, James (US)discloses eye-tracking devices and method of operation that may utilize a magnetic article associated with an eye and a sensing device to detect a magnetic field generated by the magnetic article.

U.S. Pat. No. 7,206,022; Title: CAMERA SYSTEM WITH EYE MONITORING; Inventors: MILLER, Michael E.; CEROSALETTI, Cathleen D.; FEDOROVSKAYA, Elena A.; COVANNON, Edward; EASTMAN KODAK COMPAGNY discloses a camera system that captures an image of a scene and an eye monitoring system adapted to determine eye information including direction of the gaze of an eye of a user of the camera system. A controller is adapted to store the determined eye information characterizing eye gaze direction during the image capture sequence and to associate the stored eye information with the scene image.

The three publications describing generic systems for gaze monitoring listed above do not entail monitoring with audio in conjunction with gaze, nor do they address the problems encountered by current eye tracking technologies listed above.

Other publications relating to the field of the invention include the following articles:

BILLARD Aude et al., “SEEING THROUGH THE EYES OF CHILDREN WITH AUTISM SPECTRUM DISORDERS”, Journal of Autism Research (submitted 2010). This article describes the use of a portable camera for the study of gaze behavior in children with Autistic Spectrum Disorders who are considered as having atypical glaze. The device records what children can see and what they actually look at. More specifically, while current gaze tracking systems are based on fovea recording, the system described allows to capture the “looking out of the corner of the eye” that Autism Diagnosis Observational Scales seek to assess.
NORIS Basilio et al., “ANALYSIS OF HEAD-MOUNTED WIRELESS CAMERA VIDEOS FOR EARLY DIAGNOSIS OF AUTISM”, In Proceedings of the International Conference on Computer Vision Theory and Applications, (2008). This article presents a computer based approach to analysis of the social interaction experiments for the diagnosis of autism spectrum disorders in young children. One uses face detection on videos from head-mounted wireless cameras to measure the time a child spends looking at people.

None of the current wearable technology encompasses a device for monitoring audio in conjunction with monitoring gaze and visual input that in addition avoids obtruding the field of vision of the wearer. Monitoring in conjunction these sensory channels from the view point of the user opens the door to numerous applications, not restricted to the academic ones cited above.

### SUMMARY OF THE INVENTION

Thus, while retaining all of the potential of existing gaze tracking systems, the system we propose widens the field of applications of wearable gaze tracking technology both in terms of the type of information one can gather with it (monitoring audio and vision together and from the view point of the user) and in terms of the spectrum of the population that may wear it (from early infancy through adulthood).

Furthermore we propose a totally wearable apparatus capable on the one hand to run inside as a studio solution and on the other hand capable of following outside any of the wearer's motions as an autonomous mobile version.

Possible applications include academic research on developmental psychology whereby the device is used, to measure audio and visual attention during all sorts of cognitive tasks. The unobtrusive particularity of the present device makes it particularly suited to study adult/children' behavior in social settings. In the field of robotics, it may offer a means of communication from the user to the robot, e.g. the robot could grasp attentional cues from monitoring the human's gaze. When worn by lay users, it would also provide information on how people direct their visual attention based on visual or auditory cues (or a combination of both), e.g., when choosing products on display in shopping centers, when driving or for any other activities. Seeing but also hearing things as if sitting in someone else's head may provide all sort of interesting applications covered already by the so-called spy cameras.

The device could also be worn by professional sport people and be retransmitted through TV channels, hence enabling TV viewers to watch the game from the view point of the players.

Furthermore, for people with disabilities that involve deficits in visual, motor or auditory processing, it may offer a means to better understand the way these people try to overcome these disabilities.

Finally, the application of the device is not limited to humans and could also be extended to monitoring the behavior of other animals, such as chimpanzees, dogs, etc.

### DETAILED DESCRIPTION OF THE INVENTION

The system according to the present invention provides a method to record automatically the user's audio and visual perceptions and to follow the user's gaze. It has a wide range of applications (as mentioned above), including but not restricted to monitoring visual and auditory attention in both children and adults.

Visual perception of the user refers to measurements of visual information from the view point of user by following the user's head and eye direction. Visual perception of the user is here recorded by means of one or more optical device(s), e.g. cameras attached to the fore-head of the user. The set-up provides a wider angle of view than any other known device, enabling to cover part or all of the field of view that can be scanned by the user's eyes which is not possible through currently existing eye-tracking systems.

In particular, it gives a view of the “social interaction zone” and of the “manipulation zone”. The social interaction zone refers to the area which the user sees when his/her eyes are scanning the horizontal plane and are aligned with the vertical axis of the head's frame of reference, such as when looking at people and objects from afar. The manipulation zone refers to the area which the user sees when the eyes are looking down and scanning the area below the social interaction zone, such as when the user looks at her/his hands when manipulating an object.

The user's gaze is recorded via a mirror that reflects the image of the user's eyes on a portion of the image rendered by the set of optical device(s). This part of the image can then be analyzed in relation to the field of view given by the set of optical device(s) to determine the locus of the user's gaze in the image.

Because the alignment of the mirror with the eyes may vary across users and trials, as it depends on the form and size of the forehead of the user and the exact location of the camera system on the forehead, the mirror may be actuated and its orientation can be adjusted remotely by the user or an external experimenter to ensure that the eyes are properly seen in the image. The mirror may also be adjusted to reflect an image of other parts of the face of interest, such as the mouth for example.

One may also use more than one mirror, each independently adjustable (preferably remotely), in order to be able to monitor several parts of the face of the wearer at the same time.

Finally, the mirror(s) may be replaced by any other equivalent optical device allowing to record the desired data.

Audio perception refers to measurements of audio signals that render the directionality of range of sounds perceived by the human ears. Here, audio perception is rendered by means of two or more microphones attached to the head of the user and aligned with the auditory conduit of the human ears. Of course, other equivalent means may be used as well for this purpose.

The system is tightly secured around the user head, for instance, using an elastic band with Velcro® straps for quick and flexible means of attachment. If necessary the complete system can be mounted on a cap, e.g. to make the system more acceptable by children, or onto other equivalent means.

Other uses of the system include but are not limited to computing gaze coordinates, detection and recognition of objects of interest in the scene, computing stereovision, auditory and visual synchrony analysis, analysis of auditory cues etc.

The foregoing is a summary and thus contains, by necessity, simplifications, generalizations and omissions of details; consequently, those skilled in the art will appreciate that the summary is illustrative only and is not intended to be in any way limiting. Other aspects, features, and advantages of the devices and/or processes and/or other subject matter described herein will become apparent in the teachings set forth herein.

### BRIEF DESCRIPTION OF THE DRAWINGS

The disclosed technique will be understood and appreciated more fully from the following detailed description taken in conjunction with the drawings in which:

FIG. 1 is a schematic view of the complete system, illustrating a particular positioning of the optical devices 100 and microphones 101 and 102, so as to render vision and audio as perceived by the user, and of the optical system to render gaze 103, for example a minor, with its automated mechanism 104 for adjustment;

FIG. 1A shows a side view of the optical devices of the invention;

FIG. 2 shows an embodiment of the set of optical devices with two cameras mounted vertically on top of each other;

FIG. 3 shows another embodiment of the set of cameras with two cameras mounted horizontally next to one another, so as to give a stereovision perspective on the scene;

FIG. 4 shows an embodiment in perspective view of the optical device for gaze tracking using a minor and two cameras.

### DETAILED DESCRIPTION OF THE INVENTION

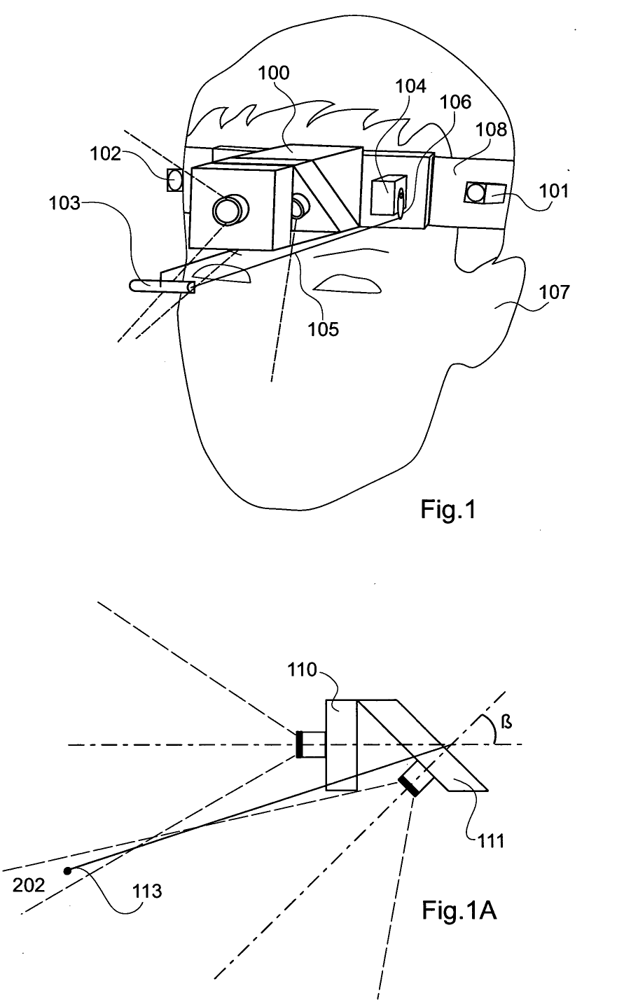

The invention is firstly described with reference to FIGS. 1 and 1A.

The device 100 according to the invention comprises at least two optical devices such as two cameras 110, 111. The main axis of the top camera 110 is aligned with that of the eyes parallax.

The second camera 111 points down and forms an angle (3 with the top camera 110, as illustrated, this angle is formed between the axis of each camera 110, 111. The angle β determines an area of overlap 202 across the images of the two cameras. The angle can be adjusted depending on the application so that the location of target of observation 113 is contained within the area of overlap to ensure a better resolution.

The choice of cameras depends on the application. In both wireless and wired versions of the system, state-of-the-art miniature cameras can be used, provided that the electronic is designed to support important change in the lighting, due to the extremely fast motion of the head, especially when worn by children. Analog systems using fiber optics may also be considered to reduce the size and weight of the system, when a wired solution is practical for the application considered.

In the embodiment of FIGS. 1 and 1A, the system in addition comprises at least one minor 103 which is used to track the gaze of the wearer. Preferable, the mirror 103 can be oriented for adjustment purposes or to be able to record other features of the wearer, for example the mouth etc. Preferably, there is at least one mirror dedicated to record the gaze of the wearer and one or more additional mirror(s) to record other features of the wearer.

The mirror(s) used are preferably actuable, i.e. movable, to properly adjust their position for the recording. As illustrated, the adjustment mechanism may comprise a motor 104 and linking means 105, 106 between the motor 104 and the mirror 103 to effect the movement of the mirror 103.

Alternatively, the mirror(s) could be replaced by equivalent means, such as camera(s) or one could use a hybrid embodiment with camera and minor.

In the embodiments disclosed above, as described, the image of the eyes (i.e. gaze) is reflected by the mirror 103 onto the lower camera 111 (FIG. 1A). Preferably, the actuation mechanism, for example a motor with actuation aims 105, 106, for the mirror is located nearby the mirror. Alternatives may also consider placing the mirror above the top camera, for instance, when considering the second embodiment of the cameras.

In addition to the optical means disclosed above, one uses here acoustical means 101, 102 preferably such as microphones in order to also be able to acquire data related to the reaction of the wearer with respect to audio stimulations. Preferably, such acoustical means are placed close to the ears 107 of the wearer to reflect a real configuration.

Accordingly, the data acquired by the optical devices may then also be analyzed and correlated with other data acquired through other means of the device, for example the influence of audio signals on the gaze of the wearer or his head position. One may, for example compare the influence of a signal on the gaze and/or the movement of the head. Of course, many different applications and combinations might be envisaged for the use of the acquired data (optical and audio).

As illustrated in the FIG. 1, the different elements of the device are mounted on a strap 108 that can be worn on the head of the user. Adjustment means are preferably added to the strap to allow a good adjustment to the user. Such means may comprise elastic parts of the strap 108, attachable and detachable means (for example Velcro® parts) and/or a combination thereof etc.

The device of the invention may also be mounted on a cap for example or another equivalent means (helmet etc) suitable for the intended use according the possibilities mentioned in the present specification (but not limited thereto).

In FIG. 1A, a side partial view of the device is illustrated. As described previously, the device comprises inter alia a camera 110 preferably with an axis aligned with the axis of the eye parallax.

A second camera 111 is placed next to the first camera (for example behind), said second camera being oriented as to acquire the image of the mirror 103, the axis of both camera having an angle β between them as described above.

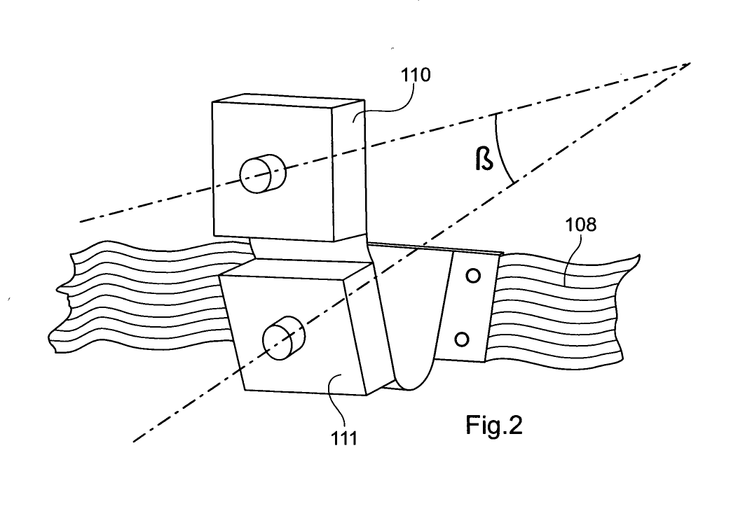

In FIG. 2, another configuration is shown where the cameras 110. 111 are not one behind the other but rather one on top of the other. In this configuration, the same principles mentioned above apply, whereby the axis of the camera 110 is aligned with the axis of the eye parallax and both cameras have an angle β between their axis. Of course, although not specifically illustrated, this embodiment (as the one of FIG. 1) also comprises at least a mirror to be able to record a feature of the wearer, preferably at least his (or her) gaze.

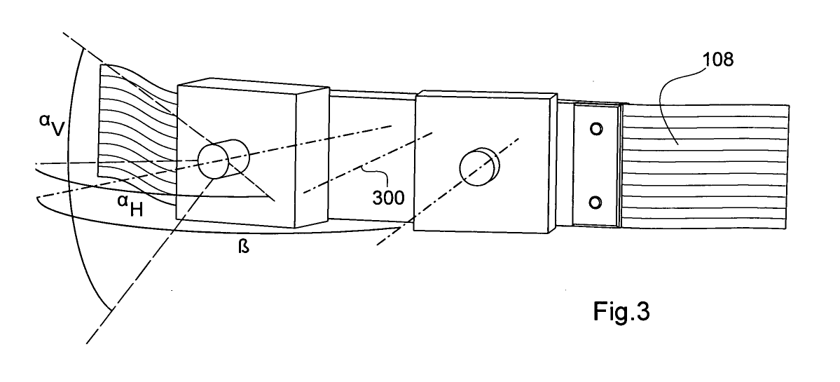

However, to vary the global angle of view of the system, one can consider placing the cameras at various angles β around the parallax 300 (see FIG. 3), as well as change the orientation of the cameras with respect to the parallax 300. Correcting for the latter change in the orientation of the image of the cameras can be done during post-processing of the images. For instance, when using two cameras with wider horizontal field of view than vertical in the embodiment of FIG. 3, one may attach the two cameras with a 90 degree angle with respect to the parallax 300 to increase the vertical coverage.

Again in this embodiment (although not specifically illustrated), at least one mirror is used to record at least one feature of the wearer, for example his (or her) gaze.

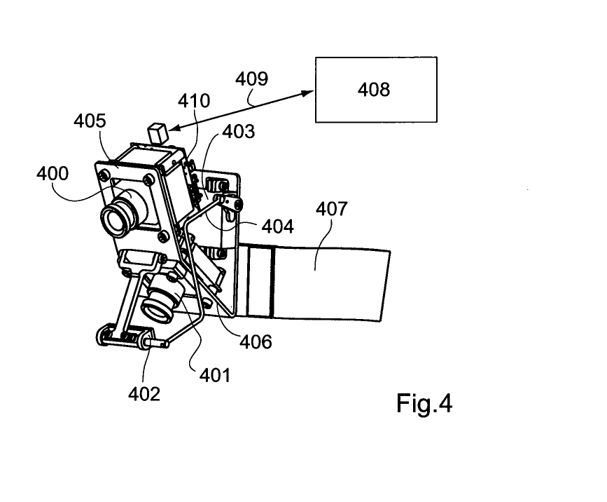

In FIG. 4, a perspective view of a device according to the present invention is shown. The device comprises two cameras 400, 401, one on top of the other, as in the embodiment of FIG. 2. As mentioned above in relation to this embodiment, the device comprises a mirror 402 that can be oriented by moving means, said moving means comprising, for example, a motor 403 and an arm 404.

The cameras 400, 401 are mounted in respective frames 405, 406 which are mounted on a strap 407. Both frames 405, 406 may be attached to the strap 407, and/or one frame may be mounted on the other frame, only one of the frames being attached to the strap 407.

The frames may be made in any suitable material, plastic or metal for example. Of course, any other suitable material may be chosen by person skilled in the art.

As mentioned previously, the system may be connected to computer means 408 by wire communication or wireless (schematically illustrated by arrow 409 in FIG. 4). Preferably, a wireless solution is chosen. In this case, the device also comprises electronic means and wireless transmitting means able to transmit the acquired information (visual and audio) to the computer means for analysis. Said electronic means and transmitting means are preferably attached to the frame(s) 405, 406 and/or to the strap 407 and are schematically illustrated by reference 410. In such case, one should of course also provide batteries or other equivalent suitable means to feed the device with appropriate energy.

Of course, all the elements present on the embodiment of FIG. 4 and not specifically illustrated in combination with the embodiments of FIGS. 1, 1A, 2 and 3 are in fact applicable to said embodiments: the computer 408, the link 409 and the electronic means 410 are usable with all the described embodiments in accordance with the principle of the present invention.

Variants that combine the embodiments described above would have the advantages of the two systems, by providing both a large angle of view and stereovision. In addition, one could automate the positioning of the optical devices to change the configurations during usage.

The description and embodiments given above are only illustrative examples that should not be construed as limiting. Variants using equivalent means and systems are possible under the spirit and scope of the present invention.

For example, the mirror used to reflect the image of the eyes, gaze, of the wearer may be oriented differently to reflect another region of interest of the face of the wearer: for example, this could be the mouth and/or another region of interest.

In another variant, the mirror could be divided in two parts such as to be able to reflect simultaneously two regions of interest of the face of the wearer. In this case, it is preferred that they are adjustable independently.

This variant may be further used to multiple mirrors reflecting multiple regions of interest. Preferably, each mirror may be adjusted independently to adapt to the user. Of course, as mentioned above, other equivalent means may be used in place of the mentioned mirrors.

In a variant, it possible to replace a mirror or several of them by one or several cameras that should be positioned in a similar manner to the mirror illustrated to be able to acquire the desired visual data. Of course, such a camera may be used alone or in combination with a mirror as illustrated previously.

The data acquired with the system of the invention may be transferred via wires or wirelessly to a computer for analysis. Typically, as is known in the art, the data acquired (optical, audio etc) by the means present in the device is transferred in electronic means (such as chips, memories etc) before being further transferred for analysis to the computer system. Said electronic means are preferably situated on the worn device. A preliminary treatment of information may be undertaken at this level to optimize the processes, for example to reduce the quantity of data being sent to the computer for analysis. Of course, it is also possible to use another method and, for example, to send all data acquired to the computer system without preliminary treatment.

This data is then analyzed according to the use that is made with the present invention.

As mentioned previously, the use of the invention is not limited to the medical field, i.e. for the diagnostic of autism but may be used in many other fields where the analysis of the behavior of the subject is of interest. This can be the case, for example to test the reaction to stimuli (visual and/or audio), for example to track the behavior of consumer and their reaction to products etc.

Also, the device of the present invention may comprises other equivalent features to the one described. For example, it may comprise means for orienting the optical devices (camera). Such means may be fixed on the device or may externally actuated (for example with a motor) so that the position of the optical devices may be adjusted without a direct external intervention on the device worn by a user. This can be helpful if the devices move on the user during use and a subsequent adjustment becomes necessary. Preferably, this is done wirelessly via for example a remote control system.

1. A wearable device for monitoring the visual information as perceived by the person wearing it and tracking the gaze of said person, comprising:
a: at least two image acquisition devices capable of capturing together at least a part of the face of the wearer and the field of view that can be scanned by the wearer's eyes;
b: at least one further image acquisition device driven by at least one actuator being used to track at least the gaze of said person.

2. The device as defined in claim 1, wherein said image acquisition devices are cameras.

3. The device as defined in claim 1, wherein said further image acquisition device is a mirror.

4. The device as defined in claim 3, wherein said mirror is flat and/or concave and/or convex.

5. The device as defined in claim 1, comprising at least one sound acquisition device capturing auditory information as perceived by the person wearing it.

6. The device as defined in claim 5, wherein said sound acquisition device comprises two microphones.

7. The device as defined in claim 1, wherein said at least two image acquisition devices are mounted one in front of the other.

8. The device as defined in claim 1, wherein said at least two image acquisition devices are mounted one on top of the other.

9. The device as defined in claim 1, wherein said at least two image acquisition devices are mounted one next to the other.

10. The device as defined in claim 1, which is mounted on a strap.

11. The device as defined in claim 1, which is mounted on a cap.

12. A system comprising a device as defined in claim 1 and a further device collecting the signal information acquired by said wearable device.

13. A system as defined in claim 12, wherein said further device collecting the signals is a computer.

14. A system as defined in claim 12, wherein the communication channel between the wearable device and the computer is a wire channel or a wireless channel.
